(19) United States
(12) Patent Application Publication
(10) Pub. No.: US 2024/0231928 A1
(43) Pub. Date: Jul. 11, 2024

(54) TECHNIQUES FOR BALANCING DYNAMIC INFERENCING BY MACHINE LEARNING MODELS

(71) Applicant: NVIDIA CORPORATION, Santa Clara, CA (US)

(72) Inventors: Jason Lavar CLEMONS, Leander, TX (US); Kavya SREEDHAR, Oakland, CA (US)

(21) Appl. No.: 18/152,528

(22) Filed: Jan. 10, 2023

(51) Int. Cl. G06F 9/50; G06N 20/00

(52) U.S. Cl. CPC G06F 9/5038; G06N 20/00

(57) ABSTRACT

Techniques are disclosed herein for allocating computational resources when executing trained machine learning models. The techniques include determining one or more available computational resources that are usable by one or more trained machine learning models to perform one or more tasks, allocating one or more computational resources to the one or more tasks based on the one or more available computational resources and one or more performance requirements associated with the one or more tasks, and causing the one or more trained machine learning models to perform the one or more tasks using the one or more computational resources allocated to the one or more tasks.

### BACKGROUND

### Technical Field

Embodiments of the present disclosure relate generally to computer science and artificial intelligence/machine learning and, more specifically, to techniques for balancing dynamic inferencing by machine learning models.

### Description of the Related Art

In machine learning (ML), data is used to train ML models for various applications or to perform certain tasks. When trained ML models are deployed in real-world applications, the amount of computational resources required to execute those ML models oftentimes varies over time in an unpredictable manner. For example, in the autonomous driving context, an ML model could be applied to detect vehicles within an environment, and another ML model could be applied to predict trajectories of the detected vehicles. The amount of computational resources required to execute such ML models would, as a general matter, depend on the number of vehicles that are detected at any given time.

One conventional approach for allocating computational resources to tasks performed using trained ML models is to assume a worst-case scenario when the trained ML models are executed. Returning to the autonomous driving example, computational resources could be allocated for the tasks of detecting vehicles and predicting trajectories of the detected vehicles under the assumption that a large number (e.g., fifteen) of vehicles are going to be detected. Additionally, or alternatively, trained ML models can be compressed or “pruned” to require fewer computational resources to execute.

One drawback of the above approaches is that, most of the time, assuming the worst-case scenario when allocating computational resources to tasks performed using trained ML models wastes computational resources that could be utilized better elsewhere. In addition, pruning trained ML models to require fewer computational resources can, as a general matter, reduce the performance of those trained ML models.

As the foregoing illustrates, what is needed in the art are more effective techniques for allocating computational resources for tasks performed using trained ML models.

### SUMMARY

One embodiment of the present disclosure sets forth a computer-implemented method for allocating computational resources when executing trained machine learning models. The method includes determining one or more available computational resources that are usable by one or more trained machine learning models to perform one or more tasks. The method further includes allocating one or more computational resources to the one or more tasks based on the one or more available computational resources and one or more performance requirements associated with the one or more tasks. In addition, the method includes causing the one or more trained machine learning models to perform the one or more tasks using the one or more computational resources allocated to the one or more tasks.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, computational resources can be allocated to tasks performed using trained ML models without wasting computational resources that could be utilized better elsewhere. In addition, with the disclosed techniques, certain levels of performance are maintained when performing tasks using trained ML models, without requiring the ML models to be compressed or pruned. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments;

FIG. 2 illustrates how a resource manager allocates computational resources to tasks performed using dynamic machine learning (ML) models, according to various embodiments;

FIG. 3 illustrates an exemplar allocation of computational resources to tasks performed using dynamic ML models, according to various embodiments;

FIG. 4 illustrates another exemplar allocation of computational resources to tasks performed using dynamic ML models, according to various embodiments;

FIG. 5 illustrates yet another exemplar allocation of computational resources to tasks performed using dynamic ML models, according to various embodiments;

FIG. 6 is a flow diagram of method steps for balancing dynamic inferencing by ML models, according to various embodiments;

FIG. 7 is a flow diagram of method steps for allocating computational resources to tasks performed using dynamic ML models, according to various embodiments; and

FIG. 8 is a flow diagram of method steps for allocating computational resources to tasks performed using dynamic ML models, according to various other embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for allocating computational resources to inferencing tasks performed using dynamic machine learning (ML) models. In some embodiments, a resource manager determines available computational resources, such as execution time, system memory, energy, or the like, on a computing system. The resource manager allocates computational resources to a number of tasks performed using dynamic ML models based on the available computational resources and performance requirements associated with the tasks. The performance requirements can include a target performance that each task should meet on average, a minimum performance requirement that each task must meet, and/or a priority associated with each task.

The disclosed techniques for allocating computational resources to tasks performed using dynamic ML models have many real-world applications. For example, those techniques could be used to allocate computational resources to tasks performed using dynamic ML models in autonomous vehicles. As another example, those techniques could be used to allocate computational resources to tasks performed using dynamic ML models in mobile devices, such as smartphones. As yet another example, those techniques could be used to allocate computational resources to tasks performed using dynamic ML models in virtual digital assistants.

The above examples are not in any way intended to be limiting. As persons skilled in the art will appreciate, as a general matter, the techniques for allocating computational resources to dynamic ML models can be implemented for any suitable application.

### System Overview

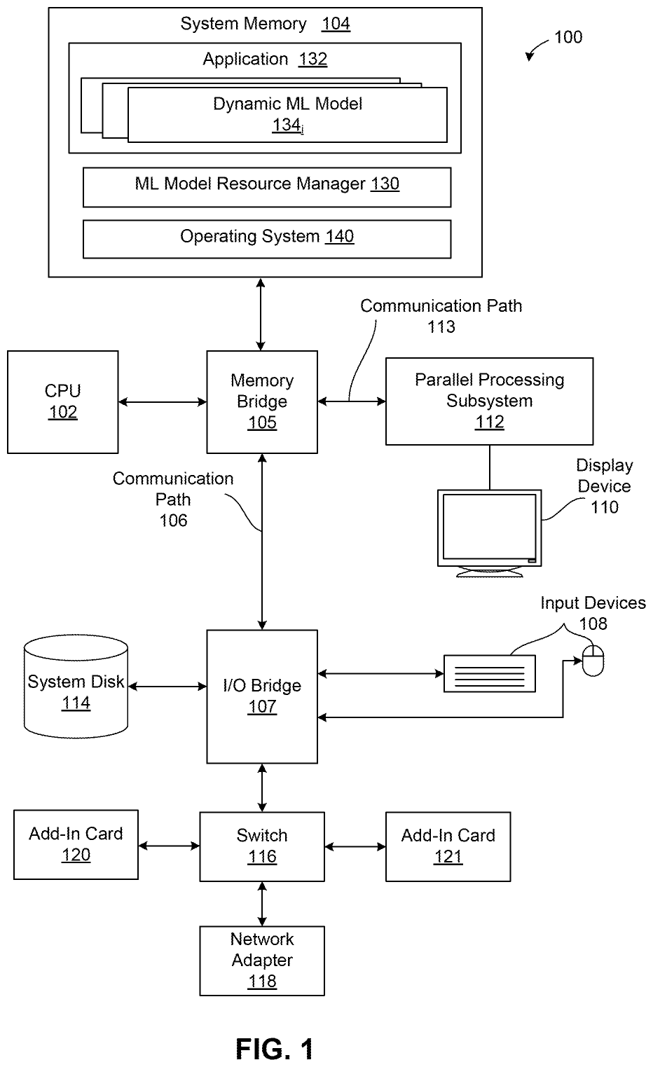

FIG. 1 illustrates a system 100 configured to implement one or more aspects of the various embodiments. As shown, the system 100 includes, without limitation, a central processing unit (CPU) 102 and a system memory 104 coupled to a parallel processing subsystem 112 via a memory bridge 105 and a communication path 113. The memory bridge 105 is further coupled to an I/O (input/output) bridge 107 via a communication path 106, and the I/O bridge 107 is, in turn, coupled to a switch 116.

In operation, the I/O bridge 107 is configured to receive user input information from one or more input devices 108, such as a keyboard, a mouse, a joystick, etc., and forward the input information to the CPU 102 for processing via the communication path 106 and the memory bridge 105. The switch 116 is configured to provide connections between the I/O bridge 107 and other components of the system 100, such as a network adapter 118 and various add-in cards 120 and 121. Although two add-in cards 120 and 121 are illustrated, in some embodiments, the system 100 may only include a single add-in card.

As also shown, the I/O bridge 107 is coupled to a system disk 114 that may be configured to store content, applications, and data for use by CPU 102 and parallel processing subsystem 112. As a general matter, the system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, movie recording devices, and the like, may be connected to the I/O bridge 107 as well.

In various embodiments, the memory bridge 105 may be a Northbridge chip, and the I/O bridge 107 may be a Southbridge chip. In addition, communication paths 106 and 113, as well as other communication paths within the system 100, may be implemented using any technically suitable protocols, including, without limitation, AGP (Accelerated Graphics Port), HyperTransport, or any other bus or point-to-point communication protocol known in the art.

In some embodiments, the parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs) included within the parallel processing subsystem 112. In other embodiments, the parallel processing subsystem 112 incorporates circuitry optimized for general purpose and/or compute processing. Again, such circuitry may be incorporated across one or more PPUs included within the parallel processing subsystem 112 that are configured to perform such general purpose and/or compute operations. In yet other embodiments, the one or more PPUs included within the parallel processing subsystem 112 may be configured to perform graphics processing, general purpose processing, and compute processing operations. The system memory 104 may include at least one device driver configured to manage the processing operations of the one or more PPUs within the parallel processing subsystem 112.

In various embodiments, the parallel processing subsystem 112 may be or include a graphics processing unit (GPU). In some embodiments, the parallel processing subsystem 112 may be integrated with one or more of the other elements of FIG. 1 to form a single system. For example, the parallel processing subsystem 112 may be integrated with the CPU 102 and other connection circuitry on a single chip to form a system on chip (SoC).

It will be appreciated that the system shown herein is illustrative and that variations and modifications are possible. The connection topology, including the number and arrangement of bridges, the number of CPUs, and the number of parallel processing subsystems, may be modified as desired. For example, in some embodiments, the system memory 104 could be connected to the CPU 102 directly rather than through the memory bridge 105, and other devices would communicate with the system memory 104 via the memory bridge 105 and the CPU 102. In other alternative topologies, the parallel processing subsystem 112 may be connected to the I/O bridge 107 or directly to the CPU 102, rather than to the memory bridge 105. In still other embodiments, the I/O bridge 107 and the memory bridge 105 may be integrated into a single chip instead of existing as one or more discrete devices. In some embodiments, any combination of the CPU 102, the parallel processing subsystem 112, and the system memory 104 may be replaced with any type of virtual computing system, distributed computing system, or cloud computing environment, such as a public cloud, a private cloud, or a hybrid cloud. Lastly, in certain embodiments, one or more components shown in FIG. 1 may not be present. For example, the switch 116 could be eliminated, and the network adapter 118 and add-in cards 120, 121 would connect directly to the I/O bridge 107.

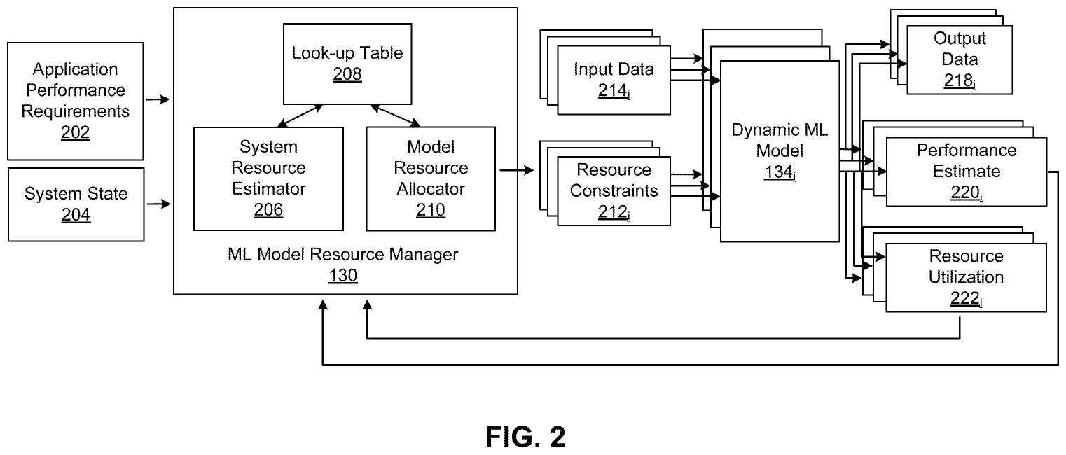

Illustratively, the system memory 104 stores a machine learning (ML) model resource manager 130 (“resource manager 130”), an application 132 that includes dynamic ML models 134i (referred to herein collectively as “dynamic ML models 134” and individually as “a dynamic ML model 134”), and an operating system (OS) 140 on which the resource manager 130, the application 132, and the dynamic ML models 134 run. The application 132 can be any technically feasible type of application, such as an autonomous vehicle application, a mobile device application, or a virtual digital assistant, that uses the dynamic ML models 134. The OS 140 may be, e.g., Linux®, Microsoft Windows®, or macOS®. The resource manager 130 is a module that allocates computational resources to inferencing tasks performed using the dynamic ML models 134 during execution of the application 132, as discussed in greater detail below in conjunction with FIGS. 2-7.

### Balancing Dynamic Inferencing by Machine Learning Models

FIG. 2 illustrates how the resource manager 130 allocates computational resources to tasks performed using the dynamic ML models 134, according to various embodiments. As shown, the resource manager 130 includes a system resource estimator 206 and a model resource allocator 210. The resource manager 130 is responsible for allocating computational resources to inferencing tasks performed using the dynamic ML models 134, and causing the dynamic ML models 134 to execute to perform the tasks based on the allocation of computational resources. In some embodiments, the dynamic ML models 134 are previously trained dynamic deep neural networks (DNNs).

In operation, the resource manager 130 receives performance requirements 202 of the application 132 that uses the dynamic ML models 134. In some embodiments, the performance requirements 202 can include target performance requirements, minimum performance requirements, and/or priorities associated with tasks performed using the dynamic ML models 134, or for the overall application 132. A target performance requirement needs to be met on average over a number of time periods, which are also referred to herein as “quanta.” A minimum performance requirement needs to be met during each time period in some embodiments. For example, the target performance requirement for a given task could indicate an average accuracy with which a dynamic ML model 134 performs the task over a number of time periods, and the minimum performance requirement for the task could indicate a minimum accuracy with which the dynamic ML model 134 performs the task during each time period. The target and minimum performance requirements are used to guarantee that certain levels of performance are maintained for tasks performed using the dynamic ML models 134. In addition to the target and minimum performance requirements, in some embodiments, the resource manager 130 accounts for the priorities of tasks when allocating computational resources to the tasks. In such cases, the task priorities can include static priorities that are provided as input in the performance requirements 202, as well as dynamic priorities that are computed based on how well the target and minimum performance requirements are being met, as discussed in greater detail below. It should be understood that target and minimum performance requirements, as well as task priorities, can differ for different types of tasks performed using dynamic ML models, as well as for different applications.

In some embodiments, one or more tasks allow for average performance, in which case dips in performance below a minimum performance requirement are permitted and corrected via increased performance during other time periods. For example, in the autonomous vehicles context, the contents of a captured video may not change much from frame to frame. When vehicles are detected using a dynamic ML model with less than a minimum accuracy in one frame, the vehicles can be detected with greater accuracy in subsequent frame(s) to meet an average accuracy requirement for the detection task. In some other embodiments, one or more tasks can dip below a minimum performance requirement under limited circumstances. Returning to the example of autonomous vehicles, a minimum accuracy for tasks could be ignored for a small number of frames at a time (e.g., 2 out of 10 frames). In some embodiments, outputs of tasks performed using dynamic ML models are filtered, thereby smoothing the outputs over time and reducing the impact of momentary reductions in performance to an application (e.g., application 132). In some embodiments, in addition to target and minimum performance requirements, the resource manager 130 also receives maximum performances (e.g., maximum accuracies) that the tasks performed using the dynamic ML models 134 can achieve.

The system resource estimator 206 persists associations between tasks performed using the dynamic models 134 and corresponding performance requirements 202, as well as computational resources utilization by the dynamic models 134 to achieve the performance requirements 202 when performing the tasks, in a look-up table 208. In some embodiments, the look-up table 208 is updated based on (1) performance estimates 220i (referred to herein collectively as “performance estimates 220” and individually as a “performance estimate 220”), such as predictions of accuracy and/or confidence, by the dynamic ML model 134 when performing the tasks; and/or (2) actual computational resource utilization 222i (referred to herein collectively as “resource utilizations 222” and individually as a “resource utilization 222”) by the dynamic ML models 134 performing the tasks. In some other embodiments, the look-up table 208 is generated prior to executing the dynamic ML models 134 to perform tasks, and the look-up table 208 is not updated based on the performance estimates 220 or the computational resource utilizations 222 by the dynamic ML models 134 performing the tasks.

At runtime, the resource manager 130 receives a state 204 of the computing system (e.g., system 100) that includes available computational resources. In some embodiments, any technically feasible computational resources can be used by the dynamic ML models 134 when performing tasks. Examples of computational resources include execution time, system memory, energy, or the like. In some embodiments, the system state 204 is obtained from an OS (e.g., OS 140) and includes resource metrics indicating the available computational resources for the tasks that need to be performed using the dynamic ML models 134. For example, in the autonomous vehicles context, video frames could be processed using (1) a dynamic ML model that performs the task of detecting vehicles in the video frames, and (2) another dynamic ML model that performs the task of predicting trajectories of the detected vehicles. In such a case, the available computational resource could be an amount of execution time that is available for processing a given video frame before a next frame needs to be processed, which can be obtained from an OS.

When certain tasks performed using dynamic ML models 134 are scheduled for execution by an OS (e.g., OS 140), the resource manager 130 allocates available computational resources to the tasks that have been scheduled for execution. For example, in some embodiments, the tasks that need to be performed using dynamic ML models, frequencies of such tasks, when such tasks are launched, etc. can be registered via an application programming interface (API), after which the OS schedules the tasks for execution and notifies the resource manager 130 of the tasks that have been scheduled for execution. In some embodiments, given tasks that have been scheduled for execution, the resource manager 130 divides the execution of tasks into time periods, or quanta, that each include a set of tasks that need to execute in a certain order, including one or more inferencing tasks using the dynamic ML models 134. Each time period can also include one or more other tasks, such as system tasks, that do not require the dynamic ML models 134. Returning to the example of autonomous vehicles, each time period could correspond to the available processing time for a video frame, and the tasks in a given time period can include detecting vehicles in the corresponding video frame and predicting trajectories of the detected vehicles.

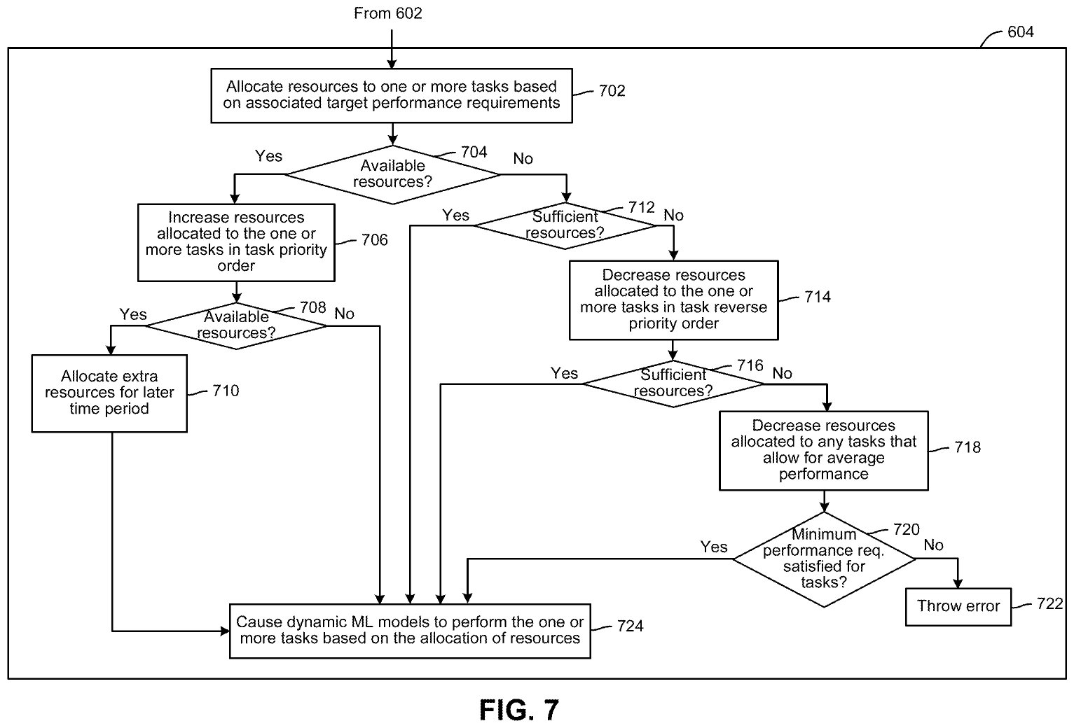

The model resource allocator 210 in the resource manager 130 allocates computational resources to tasks performed using the dynamic ML models 134 during a time period based on the available computational resources for the time period and performance requirements associated with tasks, such as a target performance requirement, a minimum performance requirement, and/or a priority associated with each task. As discussed in greater detail below in conjunction with FIG. 7, in some embodiments, the model resource allocator 210 performs a greedy allocation in which the model resource allocator 210 first queries the look-up table 208 and allocates sufficient computational resources to meet the target performance requirements associated with each task performed using the dynamic ML models 134, as indicated by the look-up table 208. If there are available computational resources after such an allocation, the model resource allocator 210 increases the computational resources allocated to the tasks performed using the dynamic ML models 134 in task priority order. If there are still available computational resources after such an allocation, the model resource allocator 210 allocates the extra computational resources for a later time period. On the other hand, if there are no available computational resources after computational resources are allocated to the tasks based on the target performance requirements, the model resource allocator 210 determines whether the available computational resources are sufficient for such an allocation. If there are insufficient available computational resources, then the model resource allocator 210 decreases the computational resources allocated to the tasks performed using the dynamic ML models 134 in task reverse priority order. If there are still insufficient computational resources, then the model resource allocator 210 decreases the computational resources allocated to tasks that allow for average performance, in which case periodic dips in performance are permitted and can be corrected via higher performance during later time periods. Assuming the minimum performance requirement, determined by querying the look-up table 208, is satisfied for all tasks performed using the dynamic ML models 134 given the allocation of computational resources to the tasks, the model resource allocator 210 causes the dynamic ML models 134 to execute and perform the tasks based on the allocation of computational resources. Otherwise, an error is thrown, and the error can be handled in any technically feasible manner, depending on the application. In some embodiments, causing the dynamic ML models 134 to perform the tasks based on the allocation of computational resources includes sending, to each dynamic ML model 134, an amount of computational resources allocated to a corresponding task, shown as resource constraints 212; (referred to herein collectively as “resource constraints 212” and individually as a “resource constraint 212”), which the dynamic ML model 134 must adhere to when performing the task. Given the resource constraints 212, each dynamic ML model 134 can automatically determine a configuration of the dynamic ML model 134 that adheres to the resource constraints 212, and then perform the corresponding task using the determined configuration. For example, the configuration could include skipping computations associated with certain layers of the dynamic ML model 134, such as large convolution layers that can be bottlenecks of some dynamic ML models. It should be noted that adhering to the resource constraints 212 can require sacrificing some performance (e.g., accuracy) when the dynamic ML models 134 perform the tasks. Additional examples of dynamic ML models that are capable of adhering to resource constraints are described in United States Patent Application titled, “DYNAMIC VISION TRANSFORMER EXECUTION FOR REAL-TIME SYSTEMS,” filed on Aug. 18, 2022 and having Ser. No. 17/820,780, and United States Provisional Patent Application titled, “AUGMENTING AND DYNAMICALLY CONFIGURING A NEURAL NETWORK MODEL FOR REAL-TIME SYSTEMS,” filed on Apr. 7, 2022 and having Ser. No. 63/328,645, which are hereby incorporated herein by reference. In some embodiments, the dynamic ML models can be compressed or pruned models that require fewer computational resources to execute. It should be noted that many dynamic ML models are resilient to reductions in computational resources and can maintain some level of performance even when fewer computational resources are allocated to tasks performed using the dynamic ML models. In some other embodiments, causing the dynamic ML models 134 to perform the tasks based on the allocation of computational resources includes determining, for each dynamic ML model 134, a configuration of the dynamic ML model 134 that requires the amount of computational resources allocated to the task, and sending the determined configuration to the dynamic ML model 134, which performs the task using the configuration. For example, associations between different configurations of the dynamic ML models 134 and corresponding computational resource requirements can be stored in, and retrieved from, the look-up table 208.

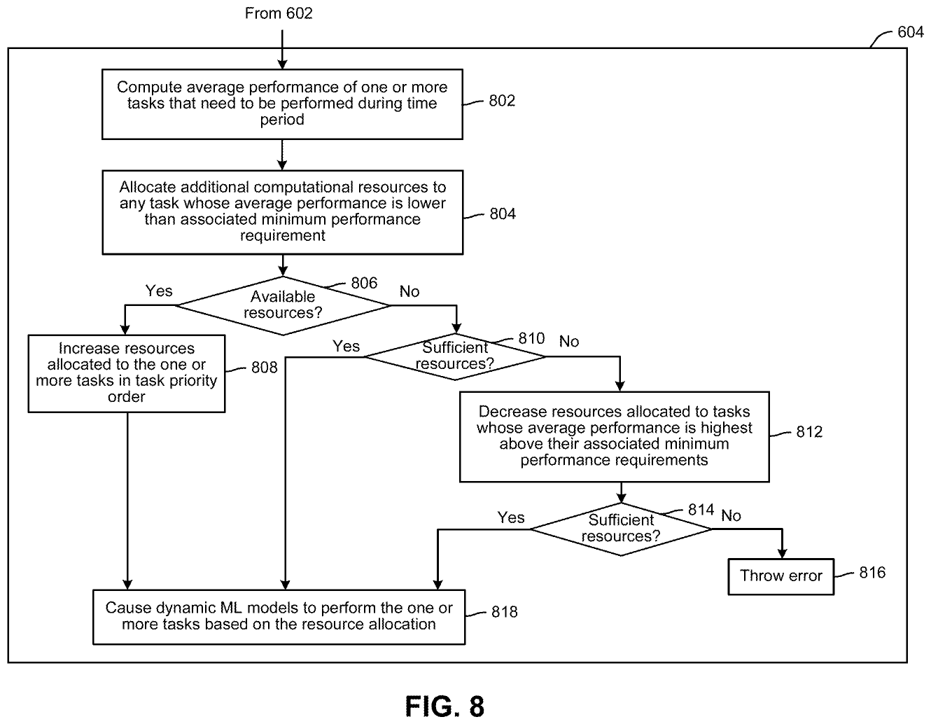

As discussed in greater detail below in conjunction with FIG. 8, in some embodiments, the model resource allocator 210 performs a greedy allocation based on the available computational resources during a time period, the minimum performance requirements of tasks performed using dynamic ML models 134, and the maximum performance achievable for the tasks. In such cases, the model resource allocator 210 first computes the average performance of each task performed using a dynamic ML model 134 over a number of time periods. For every task whose average performance is lower than an associated minimum performance requirement, the model resource allocator 210 allocates additional computational resources that, as indicated by the look-up table 208, are required to improve the performance of the task to meet the associated minimum performance requirement. If there are additional available computational resources after such an allocation of computational resources, then the model resource allocator 210 increases the allocation of computational resources to tasks performed using the dynamic ML models 134 in task priority order. If there are sufficient available computational resources in the time period for the allocation of computational resources, but no additional computational resources are available, then the dynamic ML models 134 are caused to execute and perform the tasks based on the allocation. If there are insufficient available computational resources in the time period for the allocation of computational resources, then the model resource allocator 210 decreases the allocation of computational resources to the tasks performed using the dynamic ML models 134, beginning with the tasks whose average performance is highest above their associated minimum performance requirements, which are the tasks with lowest dynamic priorities. If there are sufficient available computational resources after such a reduction in the allocation of computational resources, the model resource allocator 210 causes the dynamic ML models 134 to execute and perform the tasks based on the allocation of computational resources. Otherwise, an error is thrown, and the error can be handled in any technically feasible manner, depending on the application. An example allocation when the computational resource is execution time and the performance metric is accuracy is shown in the pseudocode of Algorithm 1. Algorithm 1 takes as inputs a total quantum execution time, a minimum accuracy of each task performed using a dynamic ML model, and a maximum accuracy of each task. Given such inputs, Algorithm 1 uses an average accuracy of each task to determine how to allocate execution time. In particular, Algorithm 1 adjusts the execution time allocation by n or (m+o) steps, depending on execution time availability and the current accuracy.

Algorithm 1:

```
Zero total execution time
For all tasks in quantum:
  Compute Average Accuracy
  If task[ave. acc.] < task[min] && task[current setting] < task[max]
    increase setting to increase accuracy proportionally to deficit
  If task[ave. acc.] >= task[current min]
    pass
  execution_time += task[est. time]
If execution_time < total time for quantum
  Add all tasks to lists
  While (execution_time < total time for quantum) && list not empty
    task = Select highest priority task in list
    task[metric target] += n steps
    Remove task from list
If execution_time > total time for quantum
  required time = (execution time − total for quantum)
  For tasks[ave. acc.] > task[min]
    task = Select task with lowest priority (highest relative accuracy)
    task [metric target] −= m steps
    required time −= (task[est. time] − task[prev est. time])
    If required time =< 0
      break
  If execution_time > total time for quantum
    Set warning for accuracy outside range
    For all tasks in inverse priority order
      task = Select task with lowest priority (highest relative accuracy)
      task[metric target] −= o steps
      required time −= (task[est. time] − task[prev est. time])
      If required time <= 0
        break
    If execution_time > total time for quantum
      Set error
```

Subsequent to the allocation of computational resources to tasks performed using dynamic ML models 134, in order to perform the tasks, input data 214i is fed into corresponding dynamic ML models 134; that each generates output data 218; and a performance estimate 220i. For example, the performance estimate 220i could be a measure of the accuracy or confidence with which the dynamic ML model 134i predicted the output data 218i. In addition, actual computational resource utilization 222; by the dynamic ML model 134i performing the tasks can be collected. In some embodiments, the actual computational resource utilization 222i can be collected by an OS (e.g., OS 140), one or more performance counters, or the like. In some embodiments, the performance estimates 220 and the actual computational resource utilizations 222 are fed back to the system resource estimator 206, which updates the look-up table 208 based on the performance estimates 220 and the actual computational resource utilizations 222, as described above.

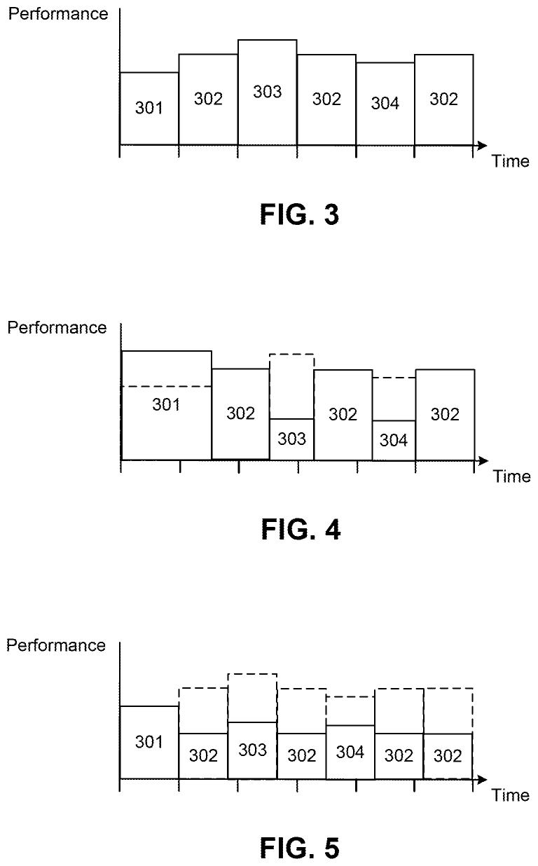

FIG. 3 illustrates an exemplar allocation of computational resources to tasks performed using dynamic ML models, according to various embodiments. As shown, the computational resource is execution time for a time period, or quantum. Returning to the autonomous vehicle example, the time period could be the execution time available for processing a single frame of a captured video. Illustratively, the execution time for the time period has been allocated equally among a task 301 that is performed once using a dynamic ML model, a task 302 that is performed three times using another dynamic ML model, a task 303 that is performed once using yet another dynamic ML model, and a task 304 that is performed once using yet another dynamic ML model. Given the equal allocation of execution times, corresponding nominal performances are achieved when the tasks 301, 302, 303, and 304 are performed. For example, the nominal performances could be certain levels of accuracy when the tasks 301, 302, 303, and 304 are performed using corresponding dynamic ML models executing for the equal execution times. In some embodiments, the nominal performances can also be used as target performance requirements for the tasks 301, 302, 303, and 304.

FIG. 4 illustrates another exemplar allocation of computational resources to tasks performed using dynamic ML models, according to various embodiments. Similar to FIG. 3, the computational resource is execution time for a time period. Relative to the computational resource allocation of FIG. 3, the task 301 has been allocated more execution time, the task 302 has been allocated the same amount of execution time, and the tasks 303 and 304 have been allocated less execution time, resulting in reduced performance for the tasks 303 and 304 relative to the nominal performances described above in conjunction with FIG. 3. The allocation of computational resources in FIG. 4 can arise if, for example, the task 301 was allocated less execution time during a previous time period and requires additional execution time to achieve a target performance requirement on average. In order to allocate additional execution time to the task 301, execution time is taken away from the tasks 303 and 304, which are the lowest priority tasks. Execution time is not taken away from the task 302, which has a higher priority than the tasks 303 and 304. That is, the manager 130 can decrease the computational resources allocated to the tasks 302, 303, and 304 in task reverse priority order, by decreasing the computational resources allocated to lower priority tasks first.

FIG. 5 illustrates yet another exemplar allocation of computational resources to tasks performed using dynamic ML models, according to various embodiments. Similar to FIGS. 3-4, the computational resource is execution time for a time period. However, the task 302 is performed four times, rather than three times, during the time period. For example, the task 302 could use a dynamic ML model to predict the trajectory of a vehicle and need to be executed an additional time when an additional vehicle is detected. Relative to the allocation of FIG. 3, the task 301 has been allocated the same amount of execution time, and the tasks 302, 303, and 304 have been allocated less execution time in order for the total execution time of the tasks to equal the time period. For example, the task 301 could require the same amount of execution time in order to, e.g., satisfy a target performance requirement or a minimum performance requirement. In addition, the tasks 302, 303, and 304 could be allocated less execution time than the task 301, resulting in reduced performance relative to the nominal performances described above in conjunction with FIG. 3, but still satisfy minimum performance requirements associated with the tasks 302, 303, and 304. It should be noted that performing the tasks 302 an additional time can be preferable to not performing the task 302, even if the performance of the tasks 302, 303, and 304 needs to be reduced. Returning to the autonomous vehicle example, detecting a vehicle and predicting a trajectory thereof with lower accuracy in a video frame can be preferable to skipping the video frame and not detecting the vehicle or predicting the trajectory.

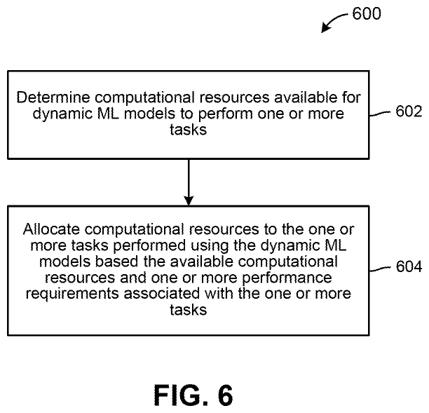

FIG. 6 is a flow diagram of method steps for balancing dynamic inferencing by ML models, according to various embodiments. Although the method steps are described in conjunction with the system of FIGS. 1-2, persons skilled in the art will understand that any system configured to perform the method steps in any order falls within the scope of the present embodiments.

As shown, a method 600 begins at step 602, where the resource manager 130 determines computational resources available for dynamic ML models to perform one or more tasks. In some embodiments, the resource manager 130 requests a system state (e.g., system state 204) from an OS (e.g., OS 140). In such cases, the available computational resources can be included in, or determined from, the system state.

At step 604, the resource manager 130 allocates computational resources to the one or more tasks performed using the dynamic ML models based on (1) the available computational resources determined at step 602, and (2) one or more performance requirements associated with the one or more tasks. In some embodiments, the resource manager 130 allocates computational resources to the one or more tasks according to the method steps described in conjunction with FIG. 7. In some other embodiments, the resource manager 130 allocates computational resources to the one or more tasks according to the method steps described in conjunction with FIG. 8.

In some embodiments, steps 602-604 of the method 600 can be repeated for each time period, or quantum, for which computational resources need to be allocated to tasks performed using dynamic ML models. Returning to the autonomous vehicle example, the steps 602-604 could be repeated to allocate execution time to the tasks of detecting vehicles and predicting trajectories thereof in a number of frames of a captured video.

FIG. 7 is a flow diagram of method steps for allocating computational resources to tasks performed using dynamic ML models at step 604 of the method 600, according to various embodiments. Although the method steps are described in conjunction with the system of FIGS. 1-2, persons skilled in the art will understand that any system configured to perform the method steps in any order falls within the scope of the present embodiments.

As shown, at step 702, the resource manager 130 allocates computational resources to the one or more tasks performed using dynamic ML models based on target performance requirements associated with the one or more tasks. As described, each target performance requirement specifies a level of performance, such as a level of accuracy or confidence, that should be achieved on average over a number of time periods. In some embodiments, the resource manager 130 determines the target performance requirements of the one or more tasks, and the corresponding computational resources that need to be allocated to the one or more tasks, by querying a look-up table (e.g., look-up table 208).

At step 704, the resource manager 130 determines whether, after the allocation of computational resources to the one or more tasks at step 702, there are available computational resources. The available computational resources are additional computational resources that can be allocated after the allocation of computational resources at step 702.

If there are available computational resources, then at step 706, the resource manager 130 increases the computational resources allocated to the one or more tasks in task priority order. In the task priority order, higher priority tasks are allocated increased computational resources first. Increasing the allocation of computational resources can improve the performance of such tasks. The priority associated with a given task can generally depend on the task and the application that performs the task. In some embodiments, if two (or more) tasks have the same priority, then the allocation of computational resources is first increased for task(s) that are furthest from associated maximum accurac(ies).

At step 708, the resource manager 130 determines whether, after the allocation at step 706, there are still available computational resources. If there are still available computational resources, then at step 710, the resource manager 130 allocates the extra available computational resources for a later time period.

If the resource manager 130 determines, at step 704, that there are no available computational resources after the allocation of computational resources at step 702, then at step 712, the resource manager 130 determines whether there are sufficient computational resources to satisfy the allocation of computational resources to the one or more tasks at step 702.

If there are insufficient computational resources to satisfy the allocation of computational resources to the one or more tasks at step 702, then at step 714, the resource manager 130 decreases the computational resources allocated to the one or more tasks in task reverse priority order. In the task reverse priority order, the computational resources allocated to lower priority tasks are decreased first. If two (or more) tasks have the same priority, then the allocation of computational resources is first decreased for task(s) that are closest to associated maximum accurac(ies).

At step 716, the resource manager 130 determines whether there are sufficient computational resources to satisfy the allocation of computational resources to the one or more tasks at step 714.

If there are insufficient computational resources to satisfy the allocation of computational resources to the one or more tasks at step 714, then at step 718, the resource manager 130 decreases the computational resources allocated to any tasks that allow for average performance. Additional computational resources can be allocated to such tasks in subsequent time periods to meet the average performance requirement.

At step 720, the resource manager 130 determines whether a minimum performance requirement is satisfied for all of the tasks. If the minimum performance is not achieved for all of the tasks, then at step 722, an error is thrown. In some embodiments, the error can be handled in any technically feasible manner, and how the error is handled will generally depend on the application.

On the other hand, if the resource manager 130 determines a minimum performance is achieved for all of the tasks at step 720, the resource manager 130 determines that there are sufficient computational resources at steps 712 or 716, the resource manager 130 determines that there are no available computational resources at step 708, or the resource manager 130 allocates extra resources at step 710, then at step 724, the resource manager 130 causes the dynamic ML models to perform the one or more tasks based on the allocation of computational resources at step 706, 714, or 718. In some embodiments, causing the dynamic ML models to perform the one or more tasks based on allocation of computational resources includes sending, to each dynamic ML model, the amount of computational resources allocated to a corresponding task. In such cases, each dynamic ML model automatically determines a configuration of the dynamic ML model that adheres to the resource allocation and performs the corresponding task using the determined configuration. In some other embodiments, causing the dynamic ML models to perform the one or more tasks based on the allocation of computational resources includes determining, for each dynamic ML model, a configuration that requires the amount of computational resources allocated to the corresponding task, and sending the determined configuration to the dynamic ML model that performs the corresponding task using the configuration.

FIG. 8 is a flow diagram of method steps for allocating computational resources to tasks performed using dynamic ML models at step 604 of the method 600, according to various other embodiments. Although the method steps are described in conjunction with the system of FIGS. 1-2, persons skilled in the art will understand that any system configured to perform the method steps in any order falls within the scope of the present embodiments.

As shown, at step 802, the resource manager 130 computes the average performance of the one or more tasks that need to be performed during a time period. In some embodiments, the average performance of each task is computed over a number of time periods using a look-up table (e.g., look-up table 208) and computational resources allocated to the tasks over the time periods, or based on actual performance estimates (e.g., performance estimates 220) for the tasks during the time periods.

At step 804, the resource manager 130 allocates additional computational resources to any task whose average performance is lower than an associated minimum performance requirement. In some embodiments, the additional computational resources are indicated by a look-up table (e.g., look-up table 208) as being required to improve the performance of the tasks to meet the associated minimum performance requirements.

At step 806, if additional computational resources are available after the allocation of computational resources at step 804, then at step 808, the resource manager 130 increases the allocation of computational resources to the one or more tasks in task priority order. Step 808 is similar to step 706, described above in conjunction with FIG. 7.

If no additional computational resources are available at step 806, then at step 810, if there are insufficient computational resources are available in the time period for the allocation of computational resources at step 804, then at step 812, the resource manager 130 decreases the allocation of computational resources to the one or more tasks, beginning with the tasks whose average performance is highest above their associated minimum performance requirements. As described, the tasks whose average performance is highest above their associated minimum performance requirements have the lowest dynamic priorities during the allocation of computational resources.

At step 814, if there are insufficient available computational resources after the allocation of computational resources at step 812, then an error is thrown at step 816. In some embodiments, the error can be handled in any technically feasible manner, and how the error is handled will generally depend on the application.

If there are sufficient available computational resources after the allocation of the computational resources at steps 810 or 814, or after the allocation of computational resources at step 808, then at step 818, the resource manager 130 causes the dynamic ML models to perform the one or more tasks based on the allocation of computational resources at step 804, 808, or 812. Step 818 is similar to step 724, described above in conjunction with FIG. 7.

In sum, techniques are disclosed for allocating computational resources to inferencing tasks performed using dynamic ML models. In some embodiments, a resource manager determines available computational resources, such as execution time, system memory, energy, or the like, on a computing system. The resource manager allocates computational resources to a number of tasks performed using dynamic ML models based on the available computational resources and performance requirements associated with the tasks. The performance requirements can include a target performance that each task should meet on average, a minimum performance requirement that each task must meet, and/or a priority associated with each task.

At least one technical advantage of the disclosed techniques relative to the prior art is that, with the disclosed techniques, computational resources can be allocated to tasks performed using trained ML models without wasting computational resources that could be utilized better elsewhere. In addition, with the disclosed techniques, certain levels of performance are maintained when performing tasks using trained ML models, without requiring the ML models to be compressed or pruned. These technical advantages represent one or more technological improvements over prior art approaches.
1. In some embodiments, a computer-implemented method for allocating computational resources when executing trained machine learning models comprises determining one or more available computational resources that are usable by one or more trained machine learning models to perform one or more tasks, allocating one or more computational resources to the one or more tasks based on the one or more available computational resources and one or more performance requirements associated with the one or more tasks, and causing the one or more trained machine learning models to perform the one or more tasks using the one or more computational resources allocated to the one or more tasks.
2. The computer-implemented method of clause 1, wherein the one or more computational resources are allocated to the one or more tasks based on one or more target performance requirements associated with the one or more tasks.
3. The computer-implemented method of clauses 1 or 2, wherein allocating the one or more computational resources to the one or more tasks comprises, if one or more additional computational resources are available after allocating the one or more computational resources based on one or more target performance requirements, allocating the one or more additional computational resources to the one or more tasks based on one or more priorities associated with the one or more tasks.
4. The computer-implemented method of any of clauses 1-3, wherein allocating the one or more computational resources to the one or more tasks comprises, if insufficient computational resources are available to allocate the one or more computational resources based on one or more target performance requirements, decreasing the one or more computational resources allocated to the one or more tasks based on one or more priorities associated with the one or more tasks.
5. The computer-implemented method of any of clauses 1-4, wherein allocating the one or more computational resources to the one or more tasks further comprises, if insufficient computational resources are available after decreasing the one or more computational resources allocated to the one or more tasks, further decreasing the one or more computational resources allocated to at least one task for which averaged performance over a plurality of time periods is permitted.
6. The computer-implemented method of any of clauses 1-5, wherein allocating the one or more computational resources to the one or more tasks comprises computing one or more performance averages associated with the one or more tasks, and allocating the one or more computational resources to the one or more tasks based on the one or more performance averages and one or more minimum performance requirements associated with the one or more tasks.
7. The computer-implemented method of any of clauses 1-6, wherein allocating the one or more computational resources to the one or more tasks further comprises decreasing one or more computational resources allocated to at least one task.
8. The computer-implemented method of any of clauses 1-7, wherein allocating the one or more computational resources to the one or more tasks comprises querying a look-up table that associates the one or more performance requirements with amounts of the one or more computational resources required by the one or more trained machine learning models to achieve the one or more performance requirements.
9. The computer-implemented method of any of clauses 1-8, further comprising updating the look-up table based on amounts of the one or more computational resources used by the one or more trained machine learning models to perform the one or more tasks.
10. The computer-implemented method of any of clauses 1-9, wherein causing the one or more trained machine learning models to perform the one or more tasks using the one or more computational resources comprises either transmitting an indication of the one or more computational resources to the one or more trained machine learning models or configuring the one or more trained machine learning models based on the one or more computational resources.
11. In some embodiments, one or more non-transitory computer-readable media store program instructions that, when executed by at least one processor, cause the at least one processor to perform the steps of determining one or more available computational resources that are usable by one or more trained machine learning models to perform one or more tasks, allocating one or more computational resources to the one or more tasks based on the one or more available computational resources and one or more performance requirements associated with the one or more tasks, and causing the one or more trained machine learning models to perform the one or more tasks using the one or more computational resources allocated to the one or more tasks.
12. The one or more non-transitory computer-readable media of clause 11, wherein the one or more computational resources are allocated to the one or more tasks based on one or more target performance requirements associated with the one or more tasks.
13. The one or more non-transitory computer-readable media of clauses 11 or 12, wherein allocating the one or more computational resources to the one or more tasks comprises, if one or more additional computational resources are available after allocating the one or more computational resources based on one or more target performance requirements, allocating the one or more additional computational resources to the one or more tasks based on one or more priorities associated with the one or more tasks.
14. The one or more non-transitory computer-readable media of any of clauses 11-13, wherein allocating the one or more computational resources to the one or more tasks comprises, if insufficient computational resources are available to allocate the one or more computational resources based on one or more target performance requirements, decreasing the one or more computational resources allocated to the one or more tasks based on one or more priorities associated with the one or more tasks.
15. The one or more non-transitory computer-readable media of any of clauses 11-14, wherein allocating the one or more computational resources to the one or more tasks comprises computing one or more performance averages associated with the one or more tasks, and allocating the one or more computational resources to the one or more tasks based on the one or more performance averages and one or more minimum performance requirements associated with the one or more tasks.
16. The one or more non-transitory computer-readable media of any of clauses 11-15, wherein allocating the one or more computational resources to the one or more tasks further comprises decreasing one or more computational resources allocated to at least one task.
17. The one or more non-transitory computer-readable media of any of clauses 11-16, wherein the one or more computational resources includes at least one of an execution time, a system memory, or an energy.
18. The one or more non-transitory computer-readable media of any of clauses 11-17, wherein the one or more performance requirements include one or more accuracy requirements associated with the one or more tasks.
19. The one or more non-transitory computer-readable media of any of clauses 11-18, wherein the one or more trained machine learning models include one or more trained dynamic deep neural networks.
20. In some embodiments, a system comprises one or more memories storing instructions, and one or more processors that are coupled to the one or more memories and, when executing the instructions, are configured to determine one or more available computational resources that are usable by one or more trained machine learning models to perform one or more tasks, allocate one or more computational resources to the one or more tasks based on the one or more available computational resources and one or more performance requirements associated with the one or more tasks, and cause the one or more trained machine learning models to perform the one or more tasks using the one or more computational resources allocated to the one or more tasks.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for allocating computational resources when executing trained machine learning models, the method comprising:
determining one or more available computational resources that are usable by one or more trained machine learning models to perform one or more tasks;
allocating one or more computational resources to the one or more tasks based on the one or more available computational resources and one or more performance requirements associated with the one or more tasks; and
causing the one or more trained machine learning models to perform the one or more tasks using the one or more computational resources allocated to the one or more tasks.

2. The computer-implemented method of claim 1, wherein the one or more computational resources are allocated to the one or more tasks based on one or more target performance requirements associated with the one or more tasks.

3. The computer-implemented method of claim 1, wherein allocating the one or more computational resources to the one or more tasks comprises, if one or more additional computational resources are available after allocating the one or more computational resources based on one or more target performance requirements, allocating the one or more additional computational resources to the one or more tasks based on one or more priorities associated with the one or more tasks.

4. The computer-implemented method of claim 1, wherein allocating the one or more computational resources to the one or more tasks comprises, if insufficient computational resources are available to allocate the one or more computational resources based on one or more target performance requirements, decreasing the one or more computational resources allocated to the one or more tasks based on one or more priorities associated with the one or more tasks.

5. The computer-implemented method of claim 4, wherein allocating the one or more computational resources to the one or more tasks further comprises, if insufficient computational resources are available after decreasing the one or more computational resources allocated to the one or more tasks, further decreasing the one or more computational resources allocated to at least one task for which averaged performance over a plurality of time periods is permitted.

6. The computer-implemented method of claim 1, wherein allocating the one or more computational resources to the one or more tasks comprises:
computing one or more performance averages associated with the one or more tasks; and
allocating the one or more computational resources to the one or more tasks based on the one or more performance averages and one or more minimum performance requirements associated with the one or more tasks.

7. The computer-implemented method of claim 6, wherein allocating the one or more computational resources to the one or more tasks further comprises decreasing one or more computational resources allocated to at least one task.

8. The computer-implemented method of claim 1, wherein allocating the one or more computational resources to the one or more tasks comprises querying a look-up table that associates the one or more performance requirements with amounts of the one or more computational resources required by the one or more trained machine learning models to achieve the one or more performance requirements.

9. The computer-implemented method of claim 8, further comprising updating the look-up table based on amounts of the one or more computational resources used by the one or more trained machine learning models to perform the one or more tasks.

10. The computer-implemented method of claim 1, wherein causing the one or more trained machine learning models to perform the one or more tasks using the one or more computational resources comprises either transmitting an indication of the one or more computational resources to the one or more trained machine learning models or configuring the one or more trained machine learning models based on the one or more computational resources.

11. One or more non-transitory computer-readable media storing program instructions that, when executed by at least one processor, cause the at least one processor to perform the steps of:
determining one or more available computational resources that are usable by one or more trained machine learning models to perform one or more tasks;
allocating one or more computational resources to the one or more tasks based on the one or more available computational resources and one or more performance requirements associated with the one or more tasks; and
causing the one or more trained machine learning models to perform the one or more tasks using the one or more computational resources allocated to the one or more tasks.

12. The one or more non-transitory computer-readable media of claim 11, wherein the one or more computational resources are allocated to the one or more tasks based on one or more target performance requirements associated with the one or more tasks.

13. The one or more non-transitory computer-readable media of claim 11, wherein allocating the one or more computational resources to the one or more tasks comprises, if one or more additional computational resources are available after allocating the one or more computational resources based on one or more target performance requirements, allocating the one or more additional computational resources to the one or more tasks based on one or more priorities associated with the one or more tasks.

14. The one or more non-transitory computer-readable media of claim 11, wherein allocating the one or more computational resources to the one or more tasks comprises, if insufficient computational resources are available to allocate the one or more computational resources based on one or more target performance requirements, decreasing the one or more computational resources allocated to the one or more tasks based on one or more priorities associated with the one or more tasks.

15. The one or more non-transitory computer-readable media of claim 11, wherein allocating the one or more computational resources to the one or more tasks comprises:
computing one or more performance averages associated with the one or more tasks; and
allocating the one or more computational resources to the one or more tasks based on the one or more performance averages and one or more minimum performance requirements associated with the one or more tasks.

16. The one or more non-transitory computer-readable media of claim 15, wherein allocating the one or more computational resources to the one or more tasks further comprises decreasing one or more computational resources allocated to at least one task.

17. The one or more non-transitory computer-readable media of claim 11, wherein the one or more computational resources includes at least one of an execution time, a system memory, or an energy.

18. The one or more non-transitory computer-readable media of claim 11, wherein the one or more performance requirements include one or more accuracy requirements associated with the one or more tasks.

19. The one or more non-transitory computer-readable media of claim 11, wherein the one or more trained machine learning models include one or more trained dynamic deep neural networks.

20. A system, comprising:
one or more memories storing instructions; and
one or more processors that are coupled to the one or more memories and, when executing the instructions, are configured to:
determine one or more available computational resources that are usable by one or more trained machine learning models to perform one or more tasks,
allocate one or more computational resources to the one or more tasks based on the one or more available computational resources and one or more performance requirements associated with the one or more tasks, and
cause the one or more trained machine learning models to perform the one or more tasks using the one or more computational resources allocated to the one or more tasks.
